(19) United States
(12) Patent Application Publication
(10) Pub. No.: US 2011/0135125 A1
(43) Pub. Date: Jun. 9, 2011

(54) METHOD, COMMUNICATION DEVICE AND COMMUNICATION SYSTEM FOR CONTROLLING SOUND FOCUSING

(76) Inventors: Wuzhou ZHAN, Shenzhen (CN); Dongqi Wang, Shenzhen (CN)

(21) Appl. No.: 13/030,893

(22) Filed: Feb. 18, 2011

Related U.S. Application Data
(63) Continuation of application No. PCT/CN2009/073283, filed on Aug. 17, 2008.

(30) Foreign Application Priority Data
Aug. 19, 2008 (CN) 200810135510.4

(51) Int. Cl. H04R 5/02

(52) U.S. Cl. 381/303

(57) ABSTRACT

A method for controlling sound focusing includes: obtaining position information of a target sound source relative to a speaker in a speaker array; and controlling sound from the speaker in the speaker array to be focused to the target sound source according to the obtained position information. A communication device includes: a position obtaining unit configured to obtain position information of a target sound source relative to a speaker in a speaker array; and a controlling unit configured to control the sound from the speaker in the speaker array to be focused to the target sound source according to the position information obtained by the position obtaining unit.

### CROSS-REFERENCE TO RELATED APPLICATIONS

This application is a continuation of International Application No. PCT/CN2009/073283, filed on Aug. 17, 2009, which claims priority to Chinese Patent Application No. 200810135510.4, filed on Aug. 19, 2008, both of which are hereby incorporated by reference in their entireties.

### FIELD OF THE INVENTION

The present invention relates to the field of communications technologies, in particular, to a method, communication device and communication system for controlling sound focusing.

### BACKGROUND OF THE INVENTION

A speaker array may aggregate sounds to the position where the audience locates, that is, the speaker array has the function of sound focusing. The speaker array with the function of sound focusing may be used in a communication device, such as a telephone terminal device and a video conference terminal device, which does not affect the work and life of other people and guarantees the security of the communication content and therefore guarantees the privacy of communications.

In the conventional art, a speaker array with the function of sound focusing is arranged in a communication device. During the control of sound focusing, the position to which sounds focus need to be adjusted continually and manually when the position of the audience changes. Therefore, it is inconvenient to use the function of sound focusing.

### SUMMARY OF THE INVENTION

The embodiments of the present invention provide a method, communication device and communication system for controlling sound focusing to control the sound from a speaker to be focused to a target sound source according to the position of a local user (that is, the target sound source).

The embodiments of the present invention provide the following technical solutions.

A method for controlling sound focusing includes:

obtaining position information of a target sound source relative to a speaker in a speaker array; and

controlling sound from the speaker in the speaker array to be focused to the target sound source according to the obtained position information.

A communication device includes:

a position obtaining unit configured to obtain position information of a target sound source relative to a speaker in a speaker array; and

a controlling unit configured to control sound from the speaker in the speaker array to be focused to the target sound source according to the position information obtained by the position obtaining unit.

A communication system includes: a target sound source, a communication device and a speaker array.

The communication device is configured to obtain position information of a target sound source relative to a speaker in a speaker array, and control sound from the speaker in the speaker array to be focused to the target sound source according to the obtained position information.

The speaker array is configured to focus the sound to the target sound source under the control of the communication device.

The technical solution brings the following benefits:

In the embodiments of the present invention, the position information of the target sound source relative to the speaker is obtained and used to control an audio signal of a remote user to be input to the speaker and focus an audio signal from the speaker to the position of the target sound source, thus automatically controlling the sound from the speaker array to be focused to the target sound source according to the position of the target sound source.

### BRIEF DESCRIPTION OF THE DRAWINGS

FIG. 1 illustrates a flowchart of a method for controlling sound focusing according to a first embodiment of the present invention;

FIG. 2 illustrates a computing diagram from a sound source to a reference microphone according to the first embodiment of the present invention;

FIG. 3 illustrates a computing diagram from a sound source to a reference speaker according to the first embodiment of the present invention;

FIG. 4 illustrates a layout diagram of a speaker array according to the first embodiment of the present invention;

FIG. 5 illustrates a diagram of controlling speaker focusing according to the first embodiment of the present invention;

FIG. 6 illustrates a flowchart of a method for controlling sound focusing according to a second embodiment of the present invention;

FIG. 7 illustrates a diagram of controlling speaker focusing according to the second embodiment of the present invention;

FIG. 8 illustrates a diagram of a speaker focusing result according to the second embodiment of the present invention;

FIG. 9 illustrates a flowchart of a method for controlling sound focusing according to a third embodiment of the present invention;

FIG. 10 illustrates a diagram of computation of an azimuth according to the third embodiment of the present invention; and

FIG. 11 illustrates a structure of a communication device according to the third embodiment of the present invention.

### DETAILED DESCRIPTION OF THE EMBODIMENTS

The embodiments of the present invention provide a method for controlling sound focusing. The method includes: obtaining the position information of a target sound source relative to a speaker; and controlling a sound from the speaker to be focused to the target sound source according to the obtained position information. The technical solution provided by the embodiments of the present invention can control the sound from a speaker array to be focused to a sound source according to the position of the sound source.

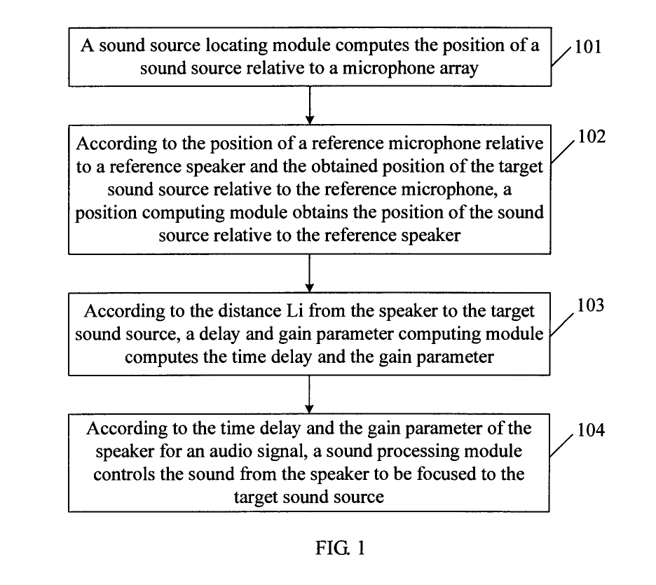

As shown in FIG. 1, a method for controlling sound focusing according to the first embodiment of the present invention includes the following steps:

101. A sound source locating module computes the position information of a sound source relative to a reference microphone.

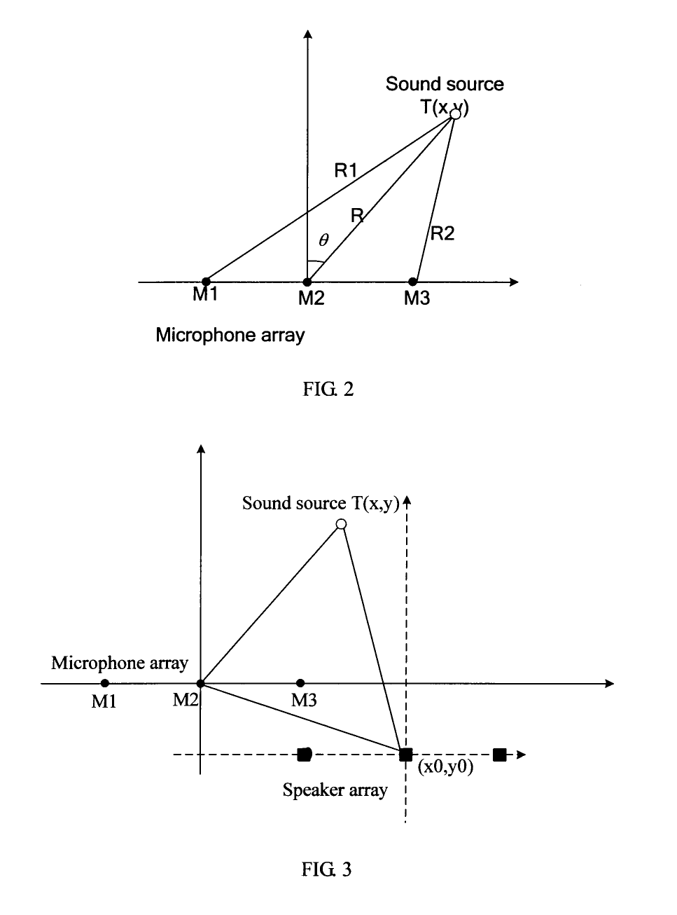

The shape of a microphone array may be linear, rectangular, round, and so on. The position of a sound source relative to the microphone array computed by the sound source locating module is the position of the sound source relative to the reference microphone. The reference microphone is in the center of the microphone array. Taking a linear microphone array composed of three microphones as an example, FIG. 2 shows how to obtain the position information of a sound source relative to a reference microphone, that is, how to compute the distance and the azimuth θ from the sound source to the reference microphone (M2), where the azimuth θ is an angle between the rectilineal direction from the sound source to the reference microphone and the vertical direction.

As illustrated in FIG. 2, assuming that T (x, y) is a sound source, and that M1, M2 and M3 are omnidirectional microphones at intervals of d. According to a voice signal received from the sound source, the obtained time delay between M1 and M2 and the obtained time delay between M2 and M3 are τ₁₂ and τ₂₃ respectively, which are multiplied by the sound speed to obtain the sound path differences between the adjacent microphones. The obtained difference (that is, the sound path difference between M1 and M2) of the sound paths from the sound source to M1 and M2 is d₁₂=τ₁₂×C where C is the sound speed. Likewise, the difference (that is, the sound path difference between M2 and M3) of the sound paths from the sound source to M2 and M3 is d₂₃=τ₂₃×C. Assuming the distances from the sound source to the microphones M1, M2 and M3 are R1, R and R3 respectively, that is, the sound source is at the intersection point of three circles respectively taking M1, M2 and M3 as centers, and R1, R and R2 as radii. Therefore, the difference d₁₂ of the sound paths from the sound source to M1 and M2 is R1−R, and the difference d₂₃ of the sound paths from the sound source to M2 and M3 is R2−R, that is, the sound path difference between the adjacent microphones is the difference of the distances from the sound source to the adjacent microphones, specifically shown in the following equations:

$$\begin{matrix}{d}_{12} = {R}_{1} - R \\ = \sqrt{{R}^{2} + 2 dR sin θ + {d}^{2}} - R \\ = d sin θ + \frac{d}{2 R} {cos}^{2} θ + θ ( \frac{{d}^{2}}{R} )\end{matrix}$$

$$\begin{matrix}{d}_{23} = {R}_{2} - R \\ = \sqrt{{R}^{2} - 2 dR sin θ + {d}^{2}} - R \\ = - d sin θ + \frac{d}{2 R} {cos}^{2} θ + θ ( \frac{{d}^{2}}{R} )\end{matrix}$$

Regardless of

$$θ ( \frac{{d}^{2}}{R} )$$

in the equations above, the equation for computing the azimuth θ and the distance R from the sound source to the reference microphone M2 is obtained as follows:

$$Sin θ = \frac{{d}_{23} + {d}_{12}}{2 d}$$

$$R = \frac{{d}^{2} {Cos}^{2} θ}{{d}_{23} + {d}_{12}}$$

Therefore, the coordinates of the sound source relative to the reference microphone are:

x=R×Sin θ

y=R×Cos θ

During the communication, besides the target sound source (i.e. local user), the microphone array may receive interference from other sound sources, such as noise sources, sounds from the remote users through speakers and other sounds from the non-target users. The first two cases may be eliminated by the methods, such as noise suppression and echo cancellation, to determine a target sound source. In the third case, the following two methods may be used to determine a target sound source. The first method is, after obtaining the distance from a sound source to a reference microphone, if the distance of the sound source relative to the reference microphone is less than a preset distance, determine that the sound source is a target sound source, if the distance of the sound source relative to the reference microphone is more than or equal to a preset distance, determine that the sound source is not a target sound source. The second method is, if a voiceprint characteristic of a sound source is that of a local user (i.e. target sound source) pre-stored in a communication device, determine that the sound source is the target sound source. During the computation of the position information of a sound source relative to a reference microphone, only the sound source in accordance with a stored voiceprint characteristic is subjected to the azimuth computation, and thus the target sound source is determined before step 101 in which a sound source locating module computes the position information of a target sound source relative to a reference microphone.

102. According to the position of a reference microphone relative to a reference speaker and the obtained position information of the target sound source relative to the reference microphone, a position computing module obtains the position information of the target sound source relative to the reference speaker.

Before the step, the position of the reference microphone relative to the reference speaker needs to be determined, and methods for obtaining the position of the reference microphone relative to the reference speaker vary with different communication systems, for example, there are the following two methods for obtaining:

1. A speaker array and a microphone array are integrated in a same communication device, so the position of the reference microphone relative to the reference speaker is fixed, and may be preset in a position computing module.

2. A speaker array and a microphone array are arranged in separate devices rather than a same communication device, so the position of the reference microphone relative to the reference speaker is variable and specifically determined below.

The speaker array is regarded as the sound source.

The microphone array receives the sound from the speaker array, and a sound source locating module connected to the microphone array computes the position of the sound source (a reference speaker in the speaker array) relative to a reference microphone in the microphone array to obtain the position of the reference microphone relative to the reference speaker. The position of the sound source (the reference speaker in the speaker array) relative to the reference microphone may be computed with reference to step 101.

The sound from the speaker array for test may be a sound from a remote user or a special test voice.

The detailed implementation of obtaining the position information of the sound source relative to the reference speaker in the step is illustrated in FIG. 3. In step 101, the obtained coordinate of the target sound source relative to the reference microphone is (x, y). Assuming the obtained computed coordinate of the reference speaker relative to the reference microphone is (x0, y0), x0 is subtracted from x to obtain x1 as the horizontal coordinate of the target sound source relative to the reference speaker and y0 is subtracted from y to obtain y1 as the vertical coordinate of the target sound source relative to the reference speaker. Thus, the position information of the target sound source relative to the reference speaker is obtained according to x1 and y1. That is, the distance L from the target sound source to the reference speaker and the angle φ between the rectilineal direction from the target sound source to the reference speaker and the vertical direction are obtained. The specific equations are as follows:

x1=x−x0

y1=y−y0

L=\sqrt{x1²+y1²}

φ=arctan(x1/y1)

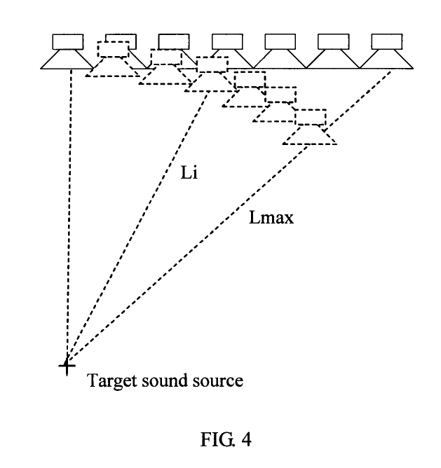

According to the layout of the speaker array, the distance from a speaker except the reference speaker in the speaker array to the target sound source is computed utilizing the distance L and the angle φ of the target sound source relative to the reference speaker, as illustrated in FIG. 4, assuming a distance from a speaker in the speaker array to the target sound source is Li.

103. A delay and gain parameter computing module computes the delay parameter (delay-time) and the gain parameter according to the distance Li from the speaker to the target sound source.

Assuming the layout of a speaker array is illustrated in FIG. 4, the process of computing the delay-time of the i^{th} speaker for an audio signal is as follows: The sounds from the speakers in the speaker array should simultaneously reach a surface of a sphere taking the target sound source as the center so that the sounds can be focused to the target sound source. In FIG. 4, the target sound source is closest to the left speaker, and when the left speaker makes a sound, the sounds from all the speakers should reach the position of the speaker shown by the dashed line, namely, a same sphere. The rightmost speaker in the figure is farthest from the target sound source, thus needing no delay, however, the leftmost speaker has the longest delay-time. Assuming Lmax is the distance from the rightmost speaker to the target sound source, and Li is the distance from the i^{th} speaker to the target sound source, the delay-time of the i^{th} speaker for the audio signal is:

τᵢ=(Lmax−Li)/C

The equation for computing the gain parameter of the i^{th} speaker for the audio signal is as follows:

$$Gain parameter of the {i}^{th} speaker for the audio signal = \frac{1}{{Li}^{2}}$$

104. A sound processing module controls the sound from the speaker to be focused to the target sound source according to the delay-time and the gain parameter of the speaker for the audio signal.

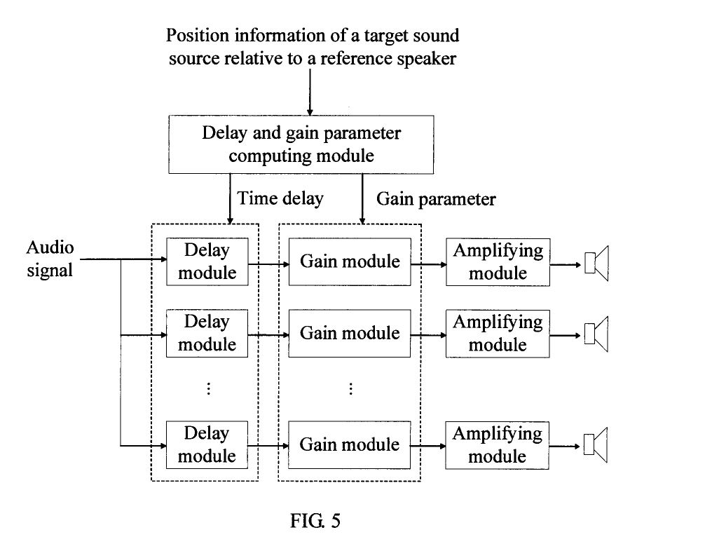

As shown in FIG. 5, the implementation of the step is: according to the delay-time of the i^{th} speaker for the audio signal, a delay module in the sound processing module controls the audio signal from a remote user to be delayed; according to the gain parameter of the i^{th} speaker for the audio signal, a gain module in the sound processing module adjusts the amplitude of the delayed audio signal; and an amplifying module amplifies the adjusted audio signal to input the amplified audio signal to the corresponding i^{th} speaker. The delay module and gain module may be filters.

In the first embodiment of the present invention, the position information of the target sound source relative to a microphone is obtained, and the position information of a target sound source relative to a speaker is obtained according to the position of the microphone relative to the speaker and the position information of the target sound source relative to the microphone, and the obtained position information of the target sound source relative to the speaker is used to compute the delay parameter of the delay module and the gain parameter of the gain module in the sound processing module, in order to control the audio signal from a remote user to be delayed, amplified and input to the speaker and focus the speaker to the position of the target sound source, thus realizing automatically controlling the sound from the speaker array to be focused to the target sound source according to the position of the target sound source.

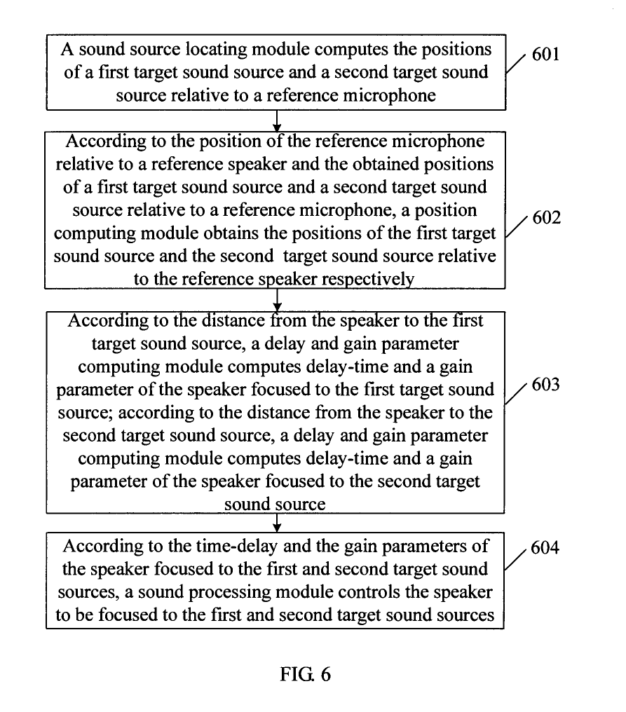

The second embodiment of the present invention provides a method for controlling sound focusing, as shown in FIG. 6. Different from the first embodiment, the second embodiment involves two target sound sources. The method includes the following steps:

601. A sound source locating module computes the position information of a first sound source and a second sound source relative to a reference microphone.

602. A position computing module obtains the position information of the first sound source and the second sound source relative to a reference speaker according to the position of the reference microphone relative to the reference speaker and the obtained position information of the first sound source and the second sound source relative to the reference microphone.

603. A delay and gain parameter computing module computes the first delay parameter and the first gain parameter of the speaker focused to the first target sound source according to the position information of the first target sound source relative to the reference speaker. The delay and gain parameter computing module computes the second delay parameter and the second gain parameter of the speaker focused to the second target sound source according to the position information of the second target sound source relative to the reference speaker.

604. A sound processing module controls the speaker to be focused to the first target sound source according to the first delay parameter and the first gain parameter of the speaker focused to the first target sound source, and controls the speaker to be focused to the second target sound source according to the second delay parameter and the second gain parameter of the speaker focused to the second target sound source.

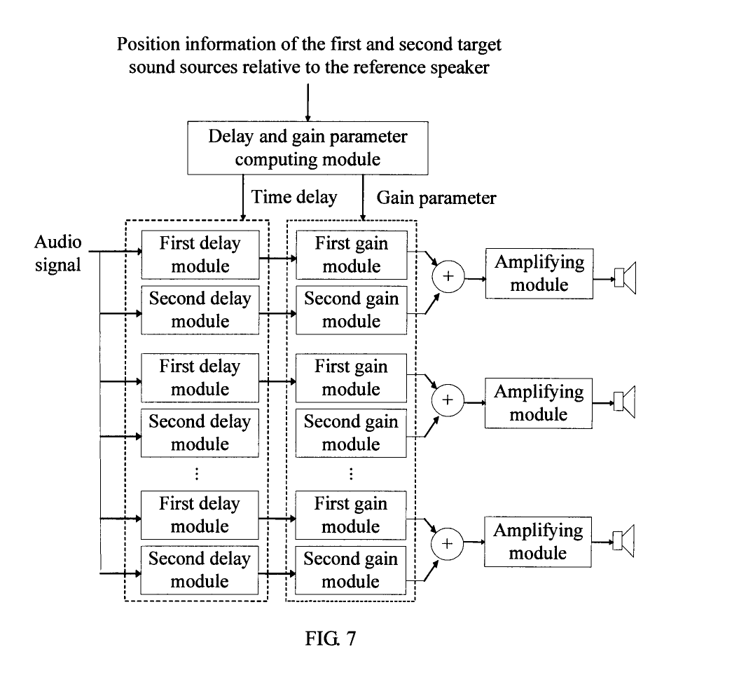

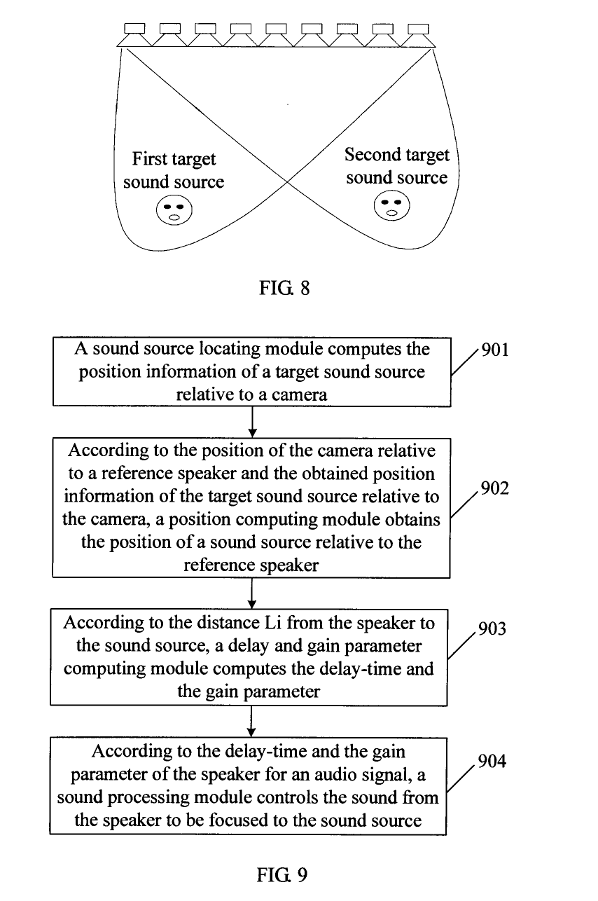

With reference to FIG. 7 and in comparison with FIG. 5, the step differs from step 104 in the first embodiment in that: a speaker corresponds to two delay modules (first delay module and second delay module) and two gain modules (first gain module and second gain module); the first delay module delays the audio signal according to the first delay parameter computed in step 603; the second delay module delays the audio signal according to the second delay parameter computed in step 603; according to the first gain parameter, the first gain module adjusts the audio signal from the first delay module to obtain a first audio signal; according to the second gain parameter, the second gain module adjusts the audio signal from the second delay module to obtain a second audio signal; the two audio signals are then combined (e.g. the two audio signals may be added) and input to an amplifying module for amplification; and the amplified audio signals are input to the speaker to focus the speaker to the first target sound source and the second target sound source, as illustrated in FIG. 8.

In the second embodiment of the present invention, the position information of the first target sound sources relative to a speaker and the position information of the second target sound sources relative to the speaker are obtained according to the position of a microphone relative to the speaker and the obtained position information of the first target sound source and the second target sound source that are relative to the microphone; the first delay parameter and the first gain parameter of the speaker focused to the first target sound sources are computed, and the second delay parameter and the second gain parameter of the speaker focused to the second target sound source are computed. Those computed delay parameters and gain parameters are used to control the speaker to be focused to the first target sound source and the second target sound source. This automatically controls the sound from a speaker array to be focused to multiple target sound sources.

The third embodiment of the present invention provides a method for controlling sound focusing, as shown in FIG. 9. The method differs from the first embodiment in obtaining the position of a sound source relative to a camera by image identification and computing the position of the sound source relative to a reference speaker according to the position of the camera relative to the reference speaker, and specifically includes the following steps:

901. A sound source locating module computes the position information of a target sound source relative to a camera.

The step specifically includes the following sub-steps:

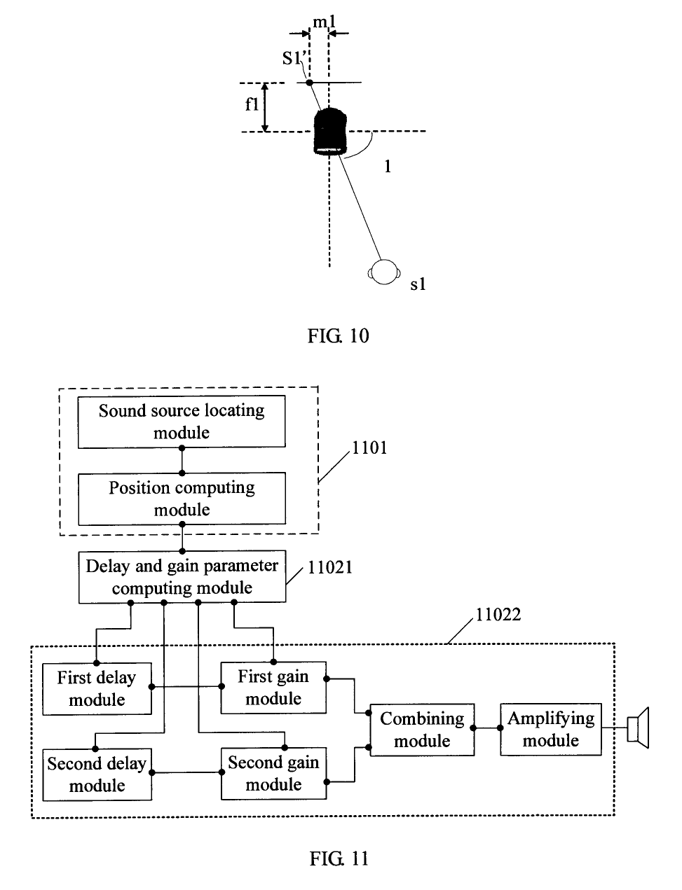

The sound source can be identified by image identification technologies. Because the sound source is human, conventional facial skin color identification technology and motion characteristics of lips identification technology may be used;
after the sound source is identified, the azimuth, an angle between the rectilineal direction from the sound source to the focus and the horizontal direction, of the sound source relative to the camera may be computed according to the position of the sound source in an image taken by the camera and the focus of the camera; with reference to FIG. 10, where the identified position of sound source s1 in the image taken by the camera is s1′, assuming the focus of the camera is f1, the distance m1 from s1′ to the image center is easy to obtain, and the azimuth θ₁ may be solved by the equation below:

$${θ}_{1} = arctan ( \frac{f 1}{m 1} )$$

the position of the sound source relative to the camera, besides the azimuth, further includes the distance information. Therefore, a stereo camera shoots the sound source and the depth information of the sound source, namely the distance information of the sound source relative to the camera, may be extracted by using technologies, such as image matching.

Before this step, the target sound source may be determined if a voiceprint characteristic of the sound source is one of a local user (target sound source) pre-stored in a communication device.

902. A position computing module obtains the position of the sound source relative to the reference speaker according to the position of the camera relative to the reference speaker and the obtained position information of the target sound source relative to the camera.

Steps 903 and 904 are the same as steps 103 and 104.

In the third embodiment of the present invention, the position information of a target sound source relative to a speaker is obtained according to the position of a camera relative to the speaker and the obtained position information of the target sound source relative to the camera, and used to compute the delay parameter of a delay module and the gain parameter of a gain module in a sound processing module, in order to control an audio signal from a remote user to be delayed, amplified and input to the speaker and focus the speaker to the position of the target sound source, thus realizing automatically controlling the sound from a speaker array to be focused to the target sound source according to the position of the target sound source.

Those skilled in the art may understand that all or part of the steps in the method embodiments may be implemented by a program instructing the relevant hardware. The program may be stored in a computer readable storage medium, such as a read only memory (ROM), a magnetic disk or a compact disk-read only memory (CD-ROM).

The fourth embodiment of the present invention provides a communication device. As shown in FIG. 11, the communication device includes:

a position obtaining unit 1101 configured to obtain the position information of a target sound source relative to a speaker in a speaker array; and

a controlling unit 1102 configured to control the sound from the speaker to be focused to the target sound source according to the position information obtained by the position obtaining unit.

The device further includes: a target sound source determining unit configured to determine the target sound source.

The position obtaining unit 1101 includes: a sound source locating module configured to obtain the position information of the target sound source relative to a microphone; and a position computing module configured to obtain the position information of the target sound source relative to the speaker according to the position of the microphone relative to the speaker and the position information of the target sound source relative to the microphone. Here, the target sound source determining unit is configured to determine the target sound source according to one or more pre-stored voiceprint characteristics of the target sound source or the distance from the sound source to the microphone.

Or, the position obtaining unit 1101 includes: a sound source locating module configured to obtain the position information of the target sound source relative to a camera; and a position computing module configured to obtain the position information of the target sound source relative to the speaker according to the position of the camera relative to the speaker and the position information of the target sound source relative to the camera. Here, the target sound source determining unit is configured to determine the target sound source according to one or more pre-stored voiceprint characteristics of the target sound source.

The controlling unit 1102 includes: a computing module 11021 and a sound processing module 11022. The computing module is called a delay and gain parameter computing module when configured to compute a delay parameter and a gain parameter of an audio signal.

The delay and gain parameter computing module is configured to compute the delay parameter and the gain parameter of the audio signal to be input to the speaker according to the obtained position information of the target sound source relative to the speaker in a speaker array.

The sound processing module is configured to delay the audio signal, adjust the delayed the audio signal and input the adjusted audio signal to the corresponding speaker according to the computed delay parameter and the computed gain parameter of the audio signal. Specifically, the sound processing module includes a delay module configured to delay the audio signal according to the delay parameter and output the delayed audio signal, and a gain module configured to adjust the amplitude of the delayed audio signal according to the gain parameter and input the adjusted audio signal to the corresponding speaker.

Preferably, the target sound source includes: a first target sound source and a second target sound source. According to the position information of the first target sound source relative to the speaker in the speaker array, the computed delay parameter and the computed gain parameters are a first delay parameter and a first gain parameter respectively; and according to the position information of the second target sound source relative to the speaker in the speaker array, the computed delay parameter and computed gain parameter are a second delay parameter and a second gain parameter respectively.

The sound processing module includes:

a first delay module configured to delay the audio signal according to the first delay parameter;

a first gain module configured to adjust the amplitude of the audio signal delayed by the first delay module according to the first gain parameter to obtain a first audio signal;

a second delay module configured to delay the audio signal according to the second delay parameter;

a second gain module configured to adjust the amplitude of the audio signal delayed by the second delay module according to the second gain parameter to obtain a second audio signal; and

a combining module configured to combine the two audio signals from the first gain module and the second gain module and input the combined audio signal to an amplifying module, where the combining module may combine the two audio signals by adding the two audio signals.

The amplifying module is configured to amplify the audio signal from the combining module and input the amplified audio signal to the corresponding speaker.

In the communication device provided by the fourth embodiment of the present invention, the position obtaining unit 1101 obtains the position information of the target sound source relative to the speaker, and the controlling unit 1102 controls the audio signal from a remote user to be input to the speaker by using the position information of the target sound source relative to the speaker to focus the speaker to the position of the target sound source, thus realizing automatically controlling the sound from the speaker array to be focused to the target sound source according to the position of the target sound source.

The fifth embodiment of the present invention provides a communication system, including: a target sound source, a communication device and a speaker array.

The communication device is configured to obtain the position information of the target sound source relative to a speaker in the speaker array and control the sound from the speaker in the speaker array to be focused to the target sound source according to the obtained position information.

The speaker array is configured to focus the sound to the target sound source under the control of the communication device.

The system further includes: a microphone array, configured to receive a sound signal of the target sound source.

The communication device is configured to: obtain the time delay between the adjacent microphones in the microphone array according to the sound signal; multiply the time delay by the sound speed to obtain the sound path difference between the adjacent microphones, where the sound path difference is the difference of the distances from the sound source to the adjacent microphones; obtain the position of the target sound source relative to a reference microphone in the microphone array according to the sound path difference; and obtain the position information of the target sound source relative to the speaker according to the position of the reference microphone relative to the speaker in the speaker array and the position information of the target sound source relative to the reference microphone.

Or, the system further includes: a camera, configured to shoot the target sound source.

The communication device is configured to obtain the position information of the target sound source relative to the camera according to an image taken by the camera; and obtain the position information of the target sound source relative to the speaker in the speaker array according to the position of the camera relative to the speaker in the speaker array and the obtained position information of the target sound source relative to the camera.

In the fifth embodiment of the present invention, the communication device obtains the position information of the target sound source relative to the speaker, and controls the sound from the speaker to be focused to the target sound source by using the obtained position information of the target sound source relative to the speaker, thus realizing automatically controlling the sound from the speaker array to be focused to the target sound source according to the position of the target sound source.

The above describes the method, communication device and communication system provided by the embodiments of the present invention in detail. It is understandable that those skilled in the art may make various modifications and variations to the present invention without departing from the spirit and concept of the present invention. To sum up, the content of the specification shall not be construed as a limitation to the present invention.

What is claimed is:

1. A method for controlling sound focusing, comprising:
obtaining position information of a target sound source relative to a speaker in a speaker array; and
controlling sound from the speaker in the speaker array to be focused to the target sound source according to the obtained position information.

2. The method according to claim 1, wherein:
obtaining the position information of the target sound source relative to the speaker in the speaker array comprises:
obtaining position information of the target sound source relative to a microphone; and
obtaining the position information of the target sound source relative to the speaker according to a position of the microphone relative to the speaker and the position information of the target sound source relative to the microphone.

3. The method according to claim 2, before obtaining the position information of the target sound source relative to the speaker in the speaker array, further comprising:
by using the speaker as a sound source, obtaining a time delay between adjacent microphones in a microphone array;
multiplying the time delay by a sound speed to obtain a sound path difference between the adjacent microphones; and
obtaining an azimuth from the speaker to a microphone in the microphone array and a distance from the speaker to the microphone according to the sound path difference to form the position of the microphone relative to the speaker.

4. The method according to claim 1, wherein:
obtaining the position information of the target sound source relative to the speaker in the speaker array comprises:
obtaining position information of the target sound source relative to a camera; and
obtaining the position information of the target sound source relative to the speaker according to a position of the camera relative to the speaker and the obtained position information of the target sound source relative to the camera.

5. The method according to claim 1, before obtaining the position information of the target sound source relative to the speaker in the speaker array, further comprising:
if a voiceprint characteristic of the sound source is a voiceprint characteristic of the target sound source pre-stored, determining that the sound source is the target sound source.

6. The method according to claim 2, before obtaining the position information of the target sound source relative to the speaker in the speaker array, further comprising:
obtaining a distance from the sound source to the microphone, and, if the distance is less than a preset distance, determining that the sound source is the target sound source.

7. The method according to claim 1, wherein:
controlling the sound from the speaker in the speaker array to be focused to the target sound source according to the obtained position information comprises:
computing a delay parameter of an audio signal to be input to the speaker, according to the obtained position information of the target sound source relative to the speaker in the speaker array; and controlling the audio signal to be delayed and transmitted to a corresponding speaker according to the delay parameter.

8. The method according to claim 7, wherein:
controlling the sound from the speaker in the speaker array to be focused to the target sound source further comprises:
computing a gain parameter of the audio signal to be input to the speaker, according to the obtained position information of the target sound source relative to the speaker in the speaker array; and adjusting an amplitude of the delayed audio signal according to the gain parameter and inputting the adjusted audio signal to a corresponding speaker.

9. The method according to claim 8, wherein:
the target sound source comprises: a first target sound source and a second target sound source;
according to the position information of the first target sound source relative to the speaker in the speaker array, the computed delay parameter and the computed gain parameter are a first delay parameter and a first gain parameter respectively;
according to the position information of the second target sound source relative to the speaker in the speaker array, the computed delay parameter and the computed gain parameter are second delay parameter and a second gain parameter respectively;
adjusting the amplitude of the delayed audio signal and inputting the adjusted audio signal to the corresponding speaker comprises:
according to the first gain parameter, adjusting the amplitude of the audio signal delayed according to the first delay parameter to obtain a first audio signal;
according to the second gain parameter, adjusting the amplitude of the audio signal delayed according to the second delay parameter to obtain a second audio signal; and
combining the adjusted two audio signals and inputting the combined audio signal to a reference speaker.

10. A communication device, comprising:
a position obtaining unit configured to obtain position information of a target sound source relative to a speaker in a speaker array; and
a controlling unit configured to control sound from the speaker in the speaker array to be focused to the target sound source according to the obtained position information obtained by the positioning obtaining unit.

11. The device according to claim 10, wherein:
the position obtaining unit comprises:
a sound source locating module configured to obtain position information of the target sound source relative to a microphone; and
a position computing module configured to obtain the position information of the target sound source relative to the speaker according to a position of the microphone relative to the speaker and the position information of the target sound source relative to the microphone.

12. The device according to claim 10, wherein:
the position obtaining unit comprises:
a sound source locating module configured to obtain position information of the target sound source relative to a camera; and
a position computing module configured to obtain the position information of the target sound source relative to the speaker according to a position of the camera relative to the speaker and the position information of the target sound source relative to the camera.

13. The device according to claim 10, further comprising:
a target sound source determining unit configured to determine the target sound source according to a pre-stored voiceprint characteristic of the target sound source or a distance from a sound source to a microphone.

14. The device according to claim 10, wherein the controlling unit comprises a computing module and a sound processing module, wherein:
the computing module is configured to compute a delay parameter of an audio signal to be input to the speaker according to the obtained position information of the target sound source relative to the speaker in the speaker array; and
the sound processing module comprises a delay module configured to delay the audio signal according to the delay parameter and output the delayed audio signal.

15. The device according to claim 14, wherein:
the computing module is further configured to compute a gain parameter of the audio signal to be input to the speaker according to the obtained position information of the target sound source relative to the speaker in the speaker array; and
the sound processing module further comprises a gain module configured to adjust an amplitude of the audio signal output by the delay module according to the gain parameter and input the adjusted audio signal to a corresponding speaker.

16. The device according to claim 15, wherein:
the target sound source comprises: a first target sound source and a second target sound source;
the delay parameter and the gain parameter computed by the computing module according to the position information of the first target sound source relative to the speaker are a first delay parameter and a first gain parameter respectively, and the delay parameter and the gain parameter computed by the computing module according to the position information of the second target sound source relative to the speaker are a second delay parameter and a second gain parameter respectively;
the delay module comprises:
a first delay module configured to delay the audio signal according to the first delay parameter; and
a second delay module configured to delay the audio signal according to the second delay parameter;
the gain module comprises:
a first gain module configured to adjust the amplitude of the audio signal delayed by the first delay module according to the first gain parameter to obtain a first audio signal; and
a second gain module configured to adjust the amplitude of the audio signal delayed by the second delay module according to the second gain parameter to obtain a second audio signal;
the sound processing module further comprises: a combining module configured to combine the two audio signals from the first gain module and the second gain module.

17. A communication system, comprising a target sound source, a communication device and a speaker array, wherein:
the communication device is configured to obtain position information of the target sound source relative to a speaker in the speaker array and control sound from the speaker in the speaker array to be focused to the target sound source according to the obtained position information; and
the speaker array is configured to focus the sound to the target sound source under the control of the communication device.

18. The system according to claim 17, further comprising a microphone array, wherein:
the microphone array is configured to receive a sound signal of the target sound source; and
the communication device is configured to obtain position information of the target sound source relative to a microphone in the microphone array according to the sound signal and obtain the position information of the target sound source relative to the speaker in the speaker array according to a position of the microphone relative to the speaker in the speaker array and the position information of the target sound source relative to the microphone.

19. The system according to claim 17, further comprising: a camera, wherein:
the camera is configured to shoot the target sound source; and
the communication device is configured to obtain position information of the target sound source relative to the camera according to the an image taken by the camera and obtain the position information of the target sound source relative to the speaker in the speaker array according to a position of the camera relative to the speaker in the speaker array and the obtained position information of the target sound source relative to the camera.
